(19) United States
(12) Patent Application Publication
(10) Pub. No.: US 2002/0092151 A1
(43) Pub. Date: Jul. 18, 2002

(54) Cast spherical crown shoe of compressor

(76) Inventors: Manabu Sugiura, Kariya-shi (JP); Tomohiro Murakami, Kariya-shi (JP); Yoshio Fujita, Kariya-shi (JP); Hidetoshi Hirai, Kariya-shi (JP); Toshihiko Hirano, Kariya-shi (JP)

Correspondence Address: Woodcock Washburn LLP, One Liberty Place-46th Floor, Philadelphia, PA, 19103, US

(21) Appl. No.: 10/025,083

(22) Filed: Dec. 19, 2001

(30) Foreign Application Priority Data
Dec. 21, 2000 (JP) 2000-388420 (PAT.

(51) Int. Cl. B23P 17/00

(52) U.S. Cl. 29/527.6; 29/527.5

(57) ABSTRACT

A spherical crown shoe is fabricated from an aluminum alloy. A cast shoe member is first fabricated by casting in such a shape having a substantially flat surface and a convex curved surface, which is similar to the shape of the shoe as a product. The cast shoe member is then formed into a formed shoe member substantially in the shape of a spherical crown, by pressing. The cast shoe member is smaller in diameter and greater in height than the formed shoe member, for example.

### BACKGROUND OF THE INVENTION

1. Field of the Invention

The present invention relates to a method of fabricating a spherical crown shoe arranged between a swash plate and a piston of a swash plate type compressor.

2. Description of the Related Art

The swash plate type compressor compresses a gas by converting the rotation of the swash plate into the reciprocal motion of the pistons and, for this purpose, shoes are arranged between the swash plate and the pistons. The shoe has a substantially spherical surface on the side adapted to engage with the piston and a substantially flat surface on the side adapted to engage with the swash plate, and therefore, the shoe is generally called a hemispherical shoe. These surfaces, however, are not strictly spherical surfaces and flat surfaces, but often in the shape slightly different from spherical surfaces and flat surfaces in order to improve the sliding performance, etc. Generally, the shoe for the fixed displacement refrigerant compressor is larger than a hemisphere, and the shoe for the variable displacement refrigerant compressor is smaller than a hemisphere. For the latter, the two spherical surface portions of a pair of the shoes arranged on the opposite sides of the swash plate are required to be located substantially on a common sphere, and therefore each shoe is smaller than the hemisphere by an amount substantially equal to one half of the thickness of the swash plate. For the fixed displacement refrigerant compressor which is free of such a limitation, the shoe size is often slightly larger than the hemisphere in order not to reduce the area of the sliding surface even in the case where the flat portion of the shoe is worn. The shoes of these two types, therefore, are not strictly a hemispheres, and will be generally referred to as spherical crown shoes in this specification.

A shoe made of an aluminum-based material (aluminum or aluminum alloy) for reducing the mass is proposed in Japanese Unexamined Utility Model Publication No. 57-42180, etc. The material of the shoe is desirably an aluminum alloy having a high silicon content to reduce the mass and increase the strength of the shoe at the same time. In the prior art, the spherical crown shoe is fabricated in such a manner that an initial shoe member is produced by cutting a rod-shaped material to the required length or by punching a rolled plate, and thereafter the initial shoe member is plastically deformed to produce a spherical crown shoe as a formed shoe member. The rod-shaped material employed for this purpose is produced, for example, by continuously casting the molten metal of an aluminum alloy and extruding the resulting billet into a round bar. This round bar is cut to the desired length by a cutter such as a shearing machine thereby to produce a plurality of initial shoe members, each of which is plastically deformed thereby to produce a spherical crown shoe.

Japanese Unexamined Patent Publication No. 1-162534 discloses another method of fabricating shoes. Specifically, the rod-shaped material produced by continuously casting the molten metal of an aluminum alloy is cut to the desired length. The initial shoe member thus cut is formed into the spherical shape to produce a further shoe member, which is further plastically deformed to obtain a shoe as a formed shoe member.

Still another method of fabricating a shoe is described in the U.S. Pat. No. 5,950,480. In this method, the initial shoe member produced by casting is rolled into a rolled plate, which is punched into a further shoe member, which is plastically deformed to produce a formed shoe member.

An aluminum alloy having a high silicon content, however, has small ductility and malleability, and therefore is liable to develop cracks if the amount of plastic deformation is large. If a shoe is made of this material, it is difficult to fabricate the rod-shaped member or the rolled plate described above, and in addition, an increased plastic deformation at the time of producing a formed shoe member causes the cracking of the shoe member. Another problem is that it is difficult to secure a sufficient dimensional accuracy of the cut section of the rod-shaped member or the punched surface of the rolled plate (the side surface parallel to the punching direction is often a cylindrical portion which connects the spherical portion to the flat portion of the shoe). The difficulty of securing a shoe member high in dimensional accuracy has an adverse effect on the dimensional accuracy of the spherical crown shoe, i.e., the formed shoe member. Furthermore, the process such as cutting off the rod-shaped member or the surface machining of the spherical shoe member is required on the one hand and the material is wasted by chips generated in the fabrication process on the other hand, thereby leading to an increased production cost.

### SUMMARY OF THE INVENTION

The present invention has been achieved with the above-mentioned situation as a background, and the object of the present invention is to efficiently fabricate a spherical crown shoe high in accuracy and quality. Embodiments of the method of fabricating a spherical crown shoe according to the present invention are described below.

The present invention provides a method of fabricating spherical crown shoe, comprising the steps of: casting a first shoe member in an aluminum-based alloy, the first shoe member having a shape with a substantially flat surface and a convex curved surface, which is close to a shape of a spherical crown shoe as a product; forming a second shoe member from the first shoe member by pressing, the second shoe member having a shape of a substantially spherical crown having a substantially flat surface and a substantially convex spherical surface.

In this feature, the first shoe member having the shape substantially similar to a spherical crown shoe as a product is cast in the casting step, so the amount of the plastic deformation required in the subsequent forming may be small and it is easy to avoid an occurrence of a cracking in the shoe member. Therefore, this fabrication method is suitable especially for fabricating a spherical crown shoe from a material such as aluminum having a high silicon content of which the plastic deformation is desirably minimized.

Preferably, the casting step comprises a diecasting step.

Using diecasting, the first shoe member can be easily fabricated, with high accuracy, to a shape similar to the product. Also, the ratio of the usable material is high.

Preferably, the casting step is carried out using a die unit including a first die having a recess for forming the convex curved surface of the first shoe member and a second die having a surface for forming the flat surface, and wherein the molten metal is injected into the recess from a runner and a gate formed in at least one of parting surfaces of the first die and the second die.

Preferably, the casting step comprises a unidirectional solidification casting step in which solidification of the material advances from the flat surface side to the convex curved surface side of the first shoe member.

The unidirectional solidification casting is generally defined as a method in which after filling the molten metal in a die having an upper opening, the lower portion of the die is cooled by cooling means thereby to solidify the molten metal in the die in one direction (upward). In the case where a small component such as a shoe member is cast, however, the molten metal is not necessarily injected from the upper opening. In the unidirectional solidification casting defects such as cavity, porosity and micro shrinkage, and ingress of an oxide or the like are less liable to occur, and therefore it is possible to fabricate a shoe having a high quality and strength and superior in durability. Also, the first shoe member can be easily fabricated to the shape similar to the product and therefore a high dimensional accuracy can be secured. Further, the ratio of the usable material is high as most part of the molten metal used constitutes the first shoe member.

Preferably, the unidirectional solidification casting step is carried out using a first die having a recess for forming the convex curved surface of the first shoe member and a gate opening at the deepest part of the recess, and a second die having cooling means therein and a surface for forming the flat surface of the first shoe member.

Preferably, the step of removing a useless portion is provided between the casting step and the forming step.

A trace of the gate is unavoidably left in a part of the first shoe member fabricated by casting. Also, since the molten metal is shrunk slightly during the solidification in the casting process, bubbles are liable to be formed in the material of the finally solidified portion. In the spherical crown shoe formed from the first shoe member with bubbles generated therein, strength may be reduced, often causing an insufficient durability, and therefore, a protrusion which is not a part of a product and is useless may be formed in the vicinity of the finally solidified portion. By carrying out the forming step after removing the useless portion including the gate trace and the useless protrusion, it is possible to satisfactorily avoid the formation of a useless depression left in the surface or bubbles remaining in the internal part of the product.

Preferably, the casting step is carried out in such a manner that the convex curved surface is close to a convex spherical surface, and the first shoe member is taller and thinner than the second shoe member.

The diameter of the flat surface side of the first shoe member can be increased beyond the diameter of the flat surface side of the spherical crown shoe constituting the second shoe member. In such a case, however, burrs are often generated between the joined surfaces (parting surfaces) of the dies. In view of this, the first shoe member is set slightly thinner and slightly taller than the second shoe member, and at the time of forming, the height is reduced while at the same time utilizing the resulting surplus material to increase the thickness of the first shoe member. In this way, a shoe member having the desired shape and size can be obtained while satisfactorily avoiding the generation of burrs.

Preferably, the rate of the reduction of the height of the first shoe member to the height of the second shoe member in the forming step is not more than 20%.

The height reduction rate is desirably not more than 12%, or more desirably not more than 8%.

Preferably, the casting step is carried out in such a manner that the first shoe member has a longitudinal section substantially in the shape of an equilateral trapezoid with round shoulders, and the first shoe member is lower and thinner than the second shoe member.

In this aspect, at the time of forming, the diameter of the portion corresponding to the shoulders of the equilateral trapezoid is reduced, and the resulting surplus material flows to the two sides of the shoulders. Thus, the central portion of the first shoe member is expanded in axial direction while at the same time expanding the lateral base ends of the equilateral trapezoid toward the outer periphery. In this way, while avoiding the generation of burrs, the second shoe member having the desired shape and size can be produced accurately.

Preferably, the rate of increase in the height of the first shoe member in the forming step to the height of the second shoe member in the forming step is not more than 20%.

The rate at which the height increases is desirably not more than 12%, and more desirably not more than 8%.

Preferably, the step of surface roughness improvement for improving the surface roughness of the second shoe member is provided.

The surface roughness improvement step is preferably a barreling step.

Preferably, the step of machining the flat surface portion of the second shoe member is provided.

By carrying out the machining step, the dimensional accuracy of the spherical crown shoe can be improved as a product. At the same time, the fact that the flat surface side is machined more easily than the spherical surface side makes it possible to achieve the object of the invention at a lower cost.

Preferably, the step of covering at least a part of the surface of the second shoe member, after the forming steps, is provided. step and the machining step are carried out, the covering step is executed for an intermediate product after these steps. In the case where these steps are not executed, on the other hand, the covering step is carried out for the second shoe member as an intermediate product. The execution of the covering step can improve the slidability and the wear resistance of each spherical crown shoe.

Preferably, the aluminum-based material comprises an alsil alloy containing silicon of at least 10% by weight.

The use of an alsil alloy containing at least 10% by weight of silicon as a material of the spherical crown shoe reduces the mass of the shoe and increases the strength of the shoe at the same time, thus making it possible to produce a spherical crown shoe having high durability. Also, as described above, the problem of difficulty of forming the shoe stock high in silicon content can be obviated by the present invention.

Preferably, the spherical crown shoe is lower in height than a hemisphere.

The spherical crown shoe fabricated by this method is suitably used for the swash plate type compressor of variable displacement type.

Preferably, the spherical crown shoe is taller in height than a hemisphere.

The spherical crown shoe fabricated by this method is suitably used for the swash plate type compressor of fixed displacement type.

### BRIEF DESCRIPTION OF THE DRAWINGS

The present invention will become more apparent from the following description of the preferred embodiments, with reference to the accompanying drawings, in which:

FIG. 1 is a front sectional view showing a swash plate type compressor comprising spherical crown shoes fabricated by the fabrication method according to the embodiment of the present invention;

FIG. 2 is a front view of the spherical crown shoe;

FIG. 3 is a front sectional view explaining the casting step in the method of fabricating the spherical crown shoe;

FIG. 4 is a plan view explaining the casting step;

FIG. 5 is a front view explaining the useless portion removing step in the method of fabricating the spherical crown shoe;

FIG. 6 is a front sectional view showing pressing dies before the forming step;

FIG. 7 is a front sectional view the casting dies after the forming step;

FIG. 8 is a front sectional view showing the spherical crown after the coating step;

FIG. 9 is a front view showing a cast shoe member used in the fabrication method according to another embodiment of the present invention;

FIG. 10 is a front sectional view showing the casting step in the fabrication method according to still another embodiment of the present invention; and

FIG. 11 is a plan view showing the casting die of FIG. 10.

### DESCRIPTION OF THE PREFERRED EMBODIMENTS

A spherical crown shoe of a swash plate type compressor for an automotive air conditioner according to the preferred embodiments of the present invention will be now explained, in detail, with reference to the drawings.

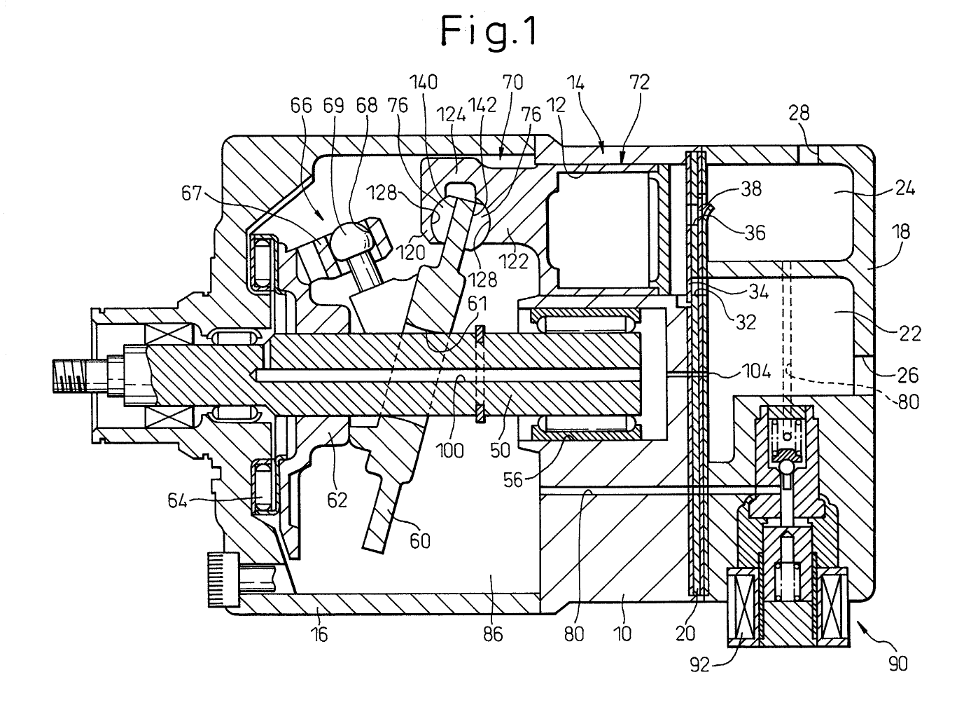

FIG. 1 shows a swash plate type compressor according to the first embodiment. In FIG. 1, reference numeral 10 designates a cylinder block, in which a plurality of cylinder bores 12 extending in axial direction are formed on a circle about the center axis of the cylinder block 10. A single-headed piston 14 (hereinafter simply called the piston 14) is reciprocably arranged in each of the cylinder bores 12. A front housing 16 is attached to the axially one end surface (the left end surface in FIG. 1, called the front end surface) of the cylinder block 10, and a rear housing 18 is attached to the other end surface (right end surface in FIG. 1, called the rear end surface) of the cylinder block 10 through a valve plate assembly 20. The front housing 16, the rear housing 18, the cylinder block 10, etc. make up the housing of the swash plate type compressor. A suction chamber 22 and a discharge chamber 24 are formed between the rear housing 18 and the valve plate assembly 20. The suction chamber 22 and the discharge chamber 24 are connected to a refrigeration circuit (not shown) through a suction port 26 and a supply port 28, respectively. Suction ports 32, suction valves 34, discharge ports 36 and discharge valves 38 are arranged in the valve plate assembly 20.

A rotary shaft 50 is rotatably arranged in the housing with the center axis of the cylinder block 10 as a rotational axis. The rotary shaft 50 is rotatably supported by the front housing 16 and the cylinder block 10 through bearings at the ends thereof, respectively. A supporting hole 56 is formed in the central portion of the cylinder block 10, and the bearing supporting one end of the rotary shaft 50 is arranged in the supporting hole 56. The end portion of the rotary shaft 50 near to the front housing 16 is coupled to the automotive engine, constituting a drive source (not shown), through a clutch unit such as an electromagnetic clutch. Thus, when the rotary shaft 50 is connected to the automotive engine by the clutch unit while the engine is operating, the rotary shaft 50 is rotated about its axis.

A swash plate 60 is mounted to the rotary shaft 50 in such a manner as to be axially movable and tiltable with respect to the rotary shaft 50. The swash plate 60 has a through hole 61 formed therein and passing through the center line thereof, and the rotary shaft 50 extends through the through hole 61. The through hole 61 is formed in such a shape that the inside dimension, as vertically in FIG. 1, is increased progressively toward the end openings thereof and the cross-sectional shape of the ends thereof is in the shape of an elongated hole. Also, a rotary plate 62 is fixed to the rotary shaft 50, and supported by the front housing 16 through a thrust bearing 64. The swash plate 60 is rotated along with the rotary shaft 50 by a hinge mechanism 66, while at the same time being allowed to incline and move in the axial direction. The hinge mechanism 66 includes support arms 67 fixedly arranged on the rotary plate 62, guide pins 69 fixedly arranged on the swash plate 60 and slidably fitted in guide holes 68 of the support arms 67, the through hole 61 of the swash plate 60, and the outer peripheral surface of the rotary shaft 50.

Each piston 14 includes an engaging portion 70 for engagement with the peripheral portion of the swash plate 60 in a sandwiching manner, and a head portion 72 integral with the engaging portion 70 and fitted in the cylinder bore 12. The head portion 72 in this embodiment is hollow to reduce the weight. The head portion 72, the cylinder bore 12 and the valve plate assembly 20 in combination make up a compression chamber. The engaging portion 70 engages with the peripheral portion of the swash plate 60 through a pair of spherical crown shoes 76. The shoes 76 will be described in detail later.

The rotational motion of the swash plates 60 is converted into the linear reciprocal motion of the pistons 14 through the shoes 76. In the suction stroke in which the piston 14 moves from the top dead center to the bottom dead center, the refrigerant gas in the suction chamber 22 is sucked into the compression chamber in the cylinder bore 12 through the suction port 32 and the suction valve 34. In the compression stroke in which the piston 14 moves from the bottom dead center to the top dead center, on the other hand, the refrigerant gas in the compression chamber in the cylinder bore 12 is compressed and discharged through the discharge port 36 and the discharge valve 38. With the compression of the refrigerant gas, the compression reaction in axial direction is exerted on the piston 14. The compression reaction is received by the front housing 16 through the piston 14, the swash plate 60, the rotary plate 62 and the thrust bearing 64.

An air supply path 80 is arranged in and through the cylinder block 10 and in the rear housing 18. The discharge chamber 24 is connected to a swash plate chamber 86, formed between the front housing 16 and the cylinder block 10 through the air supply path 80. An electromagnetic control valve 90 is arranged midway of the air supply path 80. The current supplied to a solenoid 92 in the electromagnetic control valve 90 is controlled in accordance with the information such as the refrigeration load by a control unit (not shown) including a computer as a main component.

An air exhaust path 100 is arranged in the rotary shaft 50. One end of the air exhaust path 100 is opened to the support hole 56 and the other end thereof is opened to the swash plate chamber 86. The support hole 56 is connected to the suction chamber 22 through an air exhaust port 104.

This swash plate type compressor is of a variable displacement type compressor. The internal pressure in the swash plate chamber 86 is controlled utilizing the pressure difference between the discharge chamber 24 on the high pressure side and the suction chamber 22 on the low pressure side, so that the pressure difference between the pressure in the compression chamber in the cylinder bore 12 acting on one side of the piston 14 and the pressure in the swash plate chamber 86 acting on the other side of the piston 14 is regulated, so that the inclination angle of the swash plate 60 is changed to change the stroke of the pistons 14, thereby regulating the discharge capacity of the compressor. Specifically, by controlling the energization/deenergization of the electromagnetic control valve 90, the communication from the swash plate chamber 86 to the discharge chamber 24 is established or cut off, thereby controlling the pressure in the swash plate chamber 86.

The cylinder block 10 and the pistons 14 are made of an aluminum alloy which is a kind of metal, and a fluoroplastic is coated on the outer peripheral surfaces of the pistons 14. The fluoroplastic coating makes it possible to avoid the direct contact between metals of the same kind and thus prevents metals from sticking while at the same time minimizing the fitting gap between the piston 14 and the cylinder bore 12. However, the cylinder block 10, the piston 14 and the coating layer can be formed of materials other than those mentioned above.

The engaging portion 70 of the piston 14 has a generally U-shape and includes two arm portions 120 and 122 extending in parallel to each other in the direction perpendicular to the center axis of the head portion 72, and a coupling portion 124 coupling the proximal ends of the arm portions 120 and 122 to each other. The mutually facing side surfaces of the arm portions 120 and 122 have concave spherical surfaces 128, respectively. The two concave spherical surfaces 128 are located on the common spherical surface.

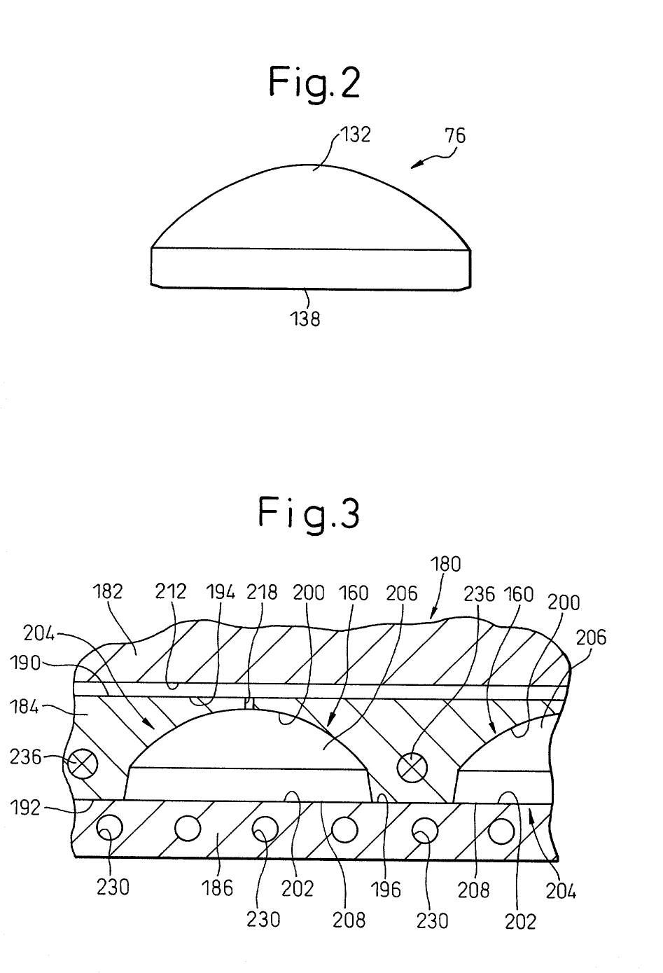

Each of the shoes 76 is shaped as a spherical crown and includes a spherical surface portion 132 in which a part of the outer surface constitutes a generally convex spherical surface and a flat surface portion 138 in which another port of the outer surface constitutes a generally flat surface, as shown in FIG. 2. The flat surface portion 138 is strictly a slightly crowned curved surface (for example, a convex spherical surface having a very large radius of curvature) and the peripheral portion of the bottom surface is tapered with a very large taper. Also, a part of the spherical surface portion 132 near the flat surface portion 138 is a cylindrical surface. The boundaries between the crowned curved surface, the tapered surface, the cylindrical surface and the convex spherical surface are rounded with a comparatively small radius of curvature. The pair of shoes 76 are slidably held at the spherical surface portions 132 thereof in the concave spherical surfaces 128 of the piston 14, and contact, at the flat surface portions 138 thereof, sliding surfaces 140 and 142 which are two side surfaces of the peripheral portion of the swash plate 60, to thereby sandwich the peripheral portion of the swash plate 60 from the two sides thereof. Under this condition, the pair of shoes 76 are designed such that the convex spherical surfaces of the spherical surface portions 132 are located on the common spherical surface. In other words, the shoes 76 according to this embodiment are each in the shape of a spherical crown smaller than a normal spherical crown by a size corresponding to about one half of the thickness of the swash plate 60. The shoes 76 are made of an alsil alloy comprising aluminum as a main component and containing silicon at not less than 10% by weight of silicon. The surface of the shoe 76 is formed with a coating layer, whereby the durability of the shoes and the slidability with piston 14 or the swash plate 60 are improved.

The shoes 76 having the configuration described above are fabricated by a fabrication method including the following steps. First, in the casting step, a cast shoe member 160 having a shape substantially close or similar to a shape of the shoe 76 as a product is cast, and in the forming step, the cast shoe member 160 is formed into a formed shoe member 162 substantially in the shape of spherical crown, by pressing (cold forging). The casting step and the forming step will be explained below.

In the casting step, the cast shoe member 160 is cast by the unidirectional solidification casting method. According to the unidirectional solidification casting method, in general, the lower portion of the die which is filled with molten metal is cooled by cooling means so that the solidification of the molten metal progresses unidirectionally from the lower portion to the upper portion. A casting die 180 as the main part of the die unit used for the unidirectional solidification casting step is schematically shown in FIGS. 3 and 4. The casting die 180 includes a stationary die 182, a first movable die 184 and a second movable die 186 which are opened and closed by being moved toward and away from each other, as shown in FIG. 3. The stationary die 182 is held by a holding plate (not shown), and removably mounted to a stationary board (not shown). The second movable die 186 is also held by a holding plate (not shown), and movably mounted to a movable board (not shown). The movable board is adapted to be moved toward and away from the stationary board by an elevating unit (not shown) as a drive unit. The first movable die 184 has parting surfaces (joining surfaces) 190 and 192 which are arranged in opposed relation to parting surfaces (joining surfaces) 194 and 196 of the stationary die 182 and the second movable die 186, respectively, and held by a slider (not shown). The slider and the movable board are coupled to each other by a transmission unit, so that when the second movable die 186 is moved toward and away from the stationary die 182, the first movable die 184 is also moved toward and away from the stationary die 182. As an alternative, the first movable die 184 and the second movable die 186 may be moved independently of each other toward and away from the stationary die 182 by respective dedicated drive units.

Cavity surfaces 200 and 202 are formed in the parting surfaces 192 and 196 of the first movable die 184 and the second movable die 186 at corresponding positions, respectively. The cavity surfaces 200 and 202 define a cavity 204 in the shape corresponding to the outer shape of the cast shoe member 160. The portion of the first movable die 184 surrounded by the cavity surface 200 defines a recess for casting mainly a portion of the outer shape of the cast shoe member 160 located on the side of the spherical surface portion 206, i.e., a substantially convex spherical surface. The cavity surface 202 of the second movable die 186 is provided for casting mainly a portion of the outer shape of the cast shoe member 160 located on the side of flat surface portion 208 having a substantially flat surface. In this embodiment, the parting surface 196 and the cavity surface 202 are formed in a common plane.

A plurality of cavities 204 are arranged in the direction parallel to the parting surfaces 192 and 196 of the first and second movable dies 184 and 186, as shown in FIG. 4, so that a plurality of cast shoe members 160 can be cast at a time in a single session of introducing the molten metal. The upper end portion (on the side near to the stationary die 182) of each cavity 204 communicates with a runner 212 and then with the internal space of a sleeve 214 having an inlet. A single runner 212 extends from the internal space of the sleeve 214 and is branched into a plurality of runners 212 from the single runner and each branch communicates with the upper end portion of the corresponding one of the cavities 204. The parting surface 194 of the stationary die 182 has a groove having a substantially semicircular cross section. With the parting surfaces 190 and 194 joined with each other, the groove is covered by the parting surface 190 and the runner 212 is thus formed. A gate 218 is formed at the end of the runner 212 on the side of each cavity 204, which gate opens to the deepest portion of the recess surrounded by the cavity surface 200 of the first movable die 184. The sleeve 214 is generally cylindrical in shape and held by the stationary die 182. A plunger 220, and a plunger tip 222 coupled to the forward end of the plunger 220 and having a diameter larger than the plunger 220 are arranged in the sleeve 214, the plunger tip 222 being fitted slidably in the sleeve 214. The plunger 220 is moved in the sleeve 214 by a plunger drive unit. The plunger drive unit can be a hydraulic cylinder providing a kind of fluid pressure cylinder. The sleeve 214, the plunger 220, the plunger tip 222 and the plunger drive unit make up an injection unit for injecting the molten metal (an alsil alloy containing aluminum as a main component with not less than 10 weight % of silicon in this embodiment) poured from the inlet toward the cavities 204.

The second movable die 186 has an internal cooling means. The cooling means includes a plurality of cooling paths 230 extending in parallel to the parting surface 196, as shown in FIG. 3, and is connected to a cooling water supply unit (not shown). As the cooling water passes through the cooling paths 230, the cavity surfaces 202 of the second movable die 186 and the neighborhood thereof are cooled. The first movable die 184 also includes heating means. The heating means shown is configured of rod-shaped electric heaters 236 extending in parallel to the parting surfaces 190 and 192 between a plurality of the cavities 204 arranged in one direction in the first movable die 184. The electric heaters 236, which are of heating units, prevent a temperature drop at the side walls of the first movable die 184 defining the cavities 204. Nevertheless, the electric heaters 236 may be omitted.

In the unidirectional solidification casting step, under the condition where the stationary die 182, the first movable die 184 and the second movable die 186 are clamped with each other and the parting surfaces 190, 192, 194 and 196 are brought in close contact with each other, the molten alsil alloy is introduced from the inlet of the sleeve 214, and the plunger tip 222 is advanced toward the cavities 204, and thus the molten metal is forced into the cavities 204 through the runner 212 and the gates 218. Even after the molten metal is filled up in the cavities 204, the plunger tip 222 continues to be driven so that the molten metal in the cavities 204 is solidified under a sufficient pressure. The portion of the molten metal in the cavity 204 near the flat surface portion 208 is first cooled by the cooling water passing through the cooling paths 230, while the cooling action from the sides of the cavity 204 is suppressed by the heat from the electric heaters 236. Therefore, the molten metal is solidified unidirectionally from the portion thereof near the flat surface 208 toward the portion thereof near the spherical surface portion 206.

According to this unidirectional solidification casting method, the solidification proceeds while defects such as cavities, porosity and micro-shrinkage developed at the time of casting are displaced upwards, and the portion farthest from the flat surface portion 208 of the cast shoe member 160 (the top of the spherical surface portion 206) is solidified at the last. Therefore, the case of the defects remaining in the cast shoe member 160 is satisfactorily avoided, and the quality and the durability of the cast shoe member 160 are improved. For this reason, an exhaust path may be desirably formed in the first movable die 184 in order to discharge the air contained in the cavities 204 at the time of casting.

After solidification of the cast shoe member 160, the casting die 180 is opened by separating the second movable die 186 and the first movable die 184 from the stationary die 182. In parallel to this operation, the cast shoe members 160 are pushed out of the recesses surrounded by the cavity surfaces 200 pushing members (not shown) arranged in the first movable die 184, thereby cutting off the material solidified in the gates 218, and then, the material solidified in the runner 212 is pushed out of the stationary die 182 by pushing members (not shown) arranged in the stationary die 182. Biscuit formed between the runner 212 and the plunger tip 222 is separated from the stationary die 182 while being kept connected to the material solidified in the runner 212 (these parts are collectively called an auxiliary portion in comparison with the cast shoe member 160 making up a product portion).

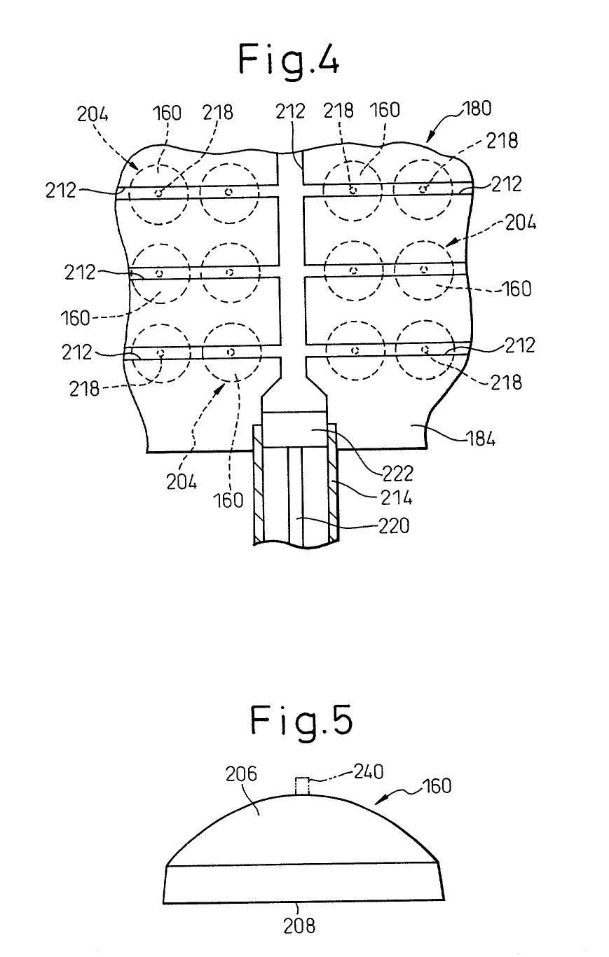

As indicated by a two-dot chain line in FIG. 5, a protrusion 240 as a part or the whole of the material solidified in the gate 218 is left at the central portion (top of the convex spherical surface) of each spherical surface portion 206 of the cast shoe members 160. This useless protrusion 240 is removed by a cutting tool or a grinding tool (not shown) in the useless portion removing step after the casting step. In the usual casting step, the molten metal is slightly shrunk when solidified, and cavity or porosity is caused in the finally solidified portion, since the molten metal is not supplied to that portion where the volume is reduced by shrinkage. In the unidirectional solidification casting method according to this embodiment, however, the finally solidified portion is the portion in the protrusion 240 or the runner 212. Once the protrusion 240 has been removed, therefore, the portion where cavity or porosity is caused is surely removed, and the cast shoe members 160 of high quality can be obtained. In order to assure this process more positively, heating means can be arranged in the stationary die 182 as well as in the first movable die 184. As another alternative, heating means is arranged only in the stationary die 182 and the heating means in the first movable die 184 is omitted.

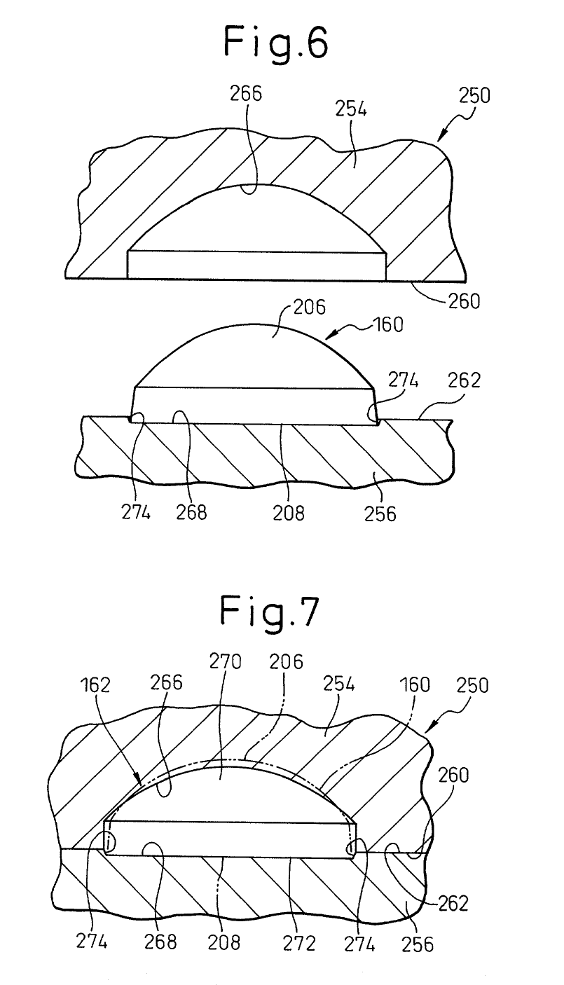

The cast shoe member 160 fabricated in the manner described above is thinner (smaller in diameter) and taller than the formed shoe member 162, so that the height is reduced and the diameter is increased in the forming step. A forging die 250 as a major part of the forming device used in the forming step is shown in FIGS. 6 and 7. The forging die 250 includes a first die 254 and a second die 256 movable toward or away from each others to be closed or opened. In this embodiment, one (the second die 256 in the shown case) of the first and second dies 254 and 256 is stationary and the other (the first die 254 in the shown case) is movable. By driving an elevating device as a drive unit (not shown), the first die 254 is moved toward or away from the second die 256. In this embodiment, the movement of the first die 254 is vertical.

The first die 254 and the second die 256 are adapted to come into contact with each other at opposing parting surfaces (matching surfaces) 260 and 262. Die surfaces 266 and 268 are formed in the parting surfaces 260 and 262 at corresponding positions. The die surfaces 266 and 268 define a cavity in the shape corresponding to the outer shape of the formed shoe member 162. The portion surrounded by the die surface 266 of the first die 254 forms a recess to form mainly a portion of the outer shape of the formed shoe member 162 on the side of the spherical surface portion 270 having a substantially convex surface. The die surface 268 forms mainly a portion of the outer shape of the formed shoe member 162 on the side of the flat surface portion 272 having a substantially flat surface. The die surface 268 of the second die 256 has a tapered surface 274 at the periphery at the bottom of a shallow circular depression.

In the forming step, first, under the condition where the first die 254 and the second die 256 are opened, the cast shoe member 160 which has been processed through the useless portion removing step is placed on the die surface 268 of the second die 256. In this instance, the cast shoe member 160 is set in position at the center of the die surface 268 of the second die 256 by the tapered surface 274 formed at the periphery of the bottom of the die surface 268. By driving the elevating device described above, the first die 254 is moved toward the second die 256, so that the most protruded portion of the spherical surface portion 206 of the cast shoe member 160 is soon brought in abutment with the die surface 266 of the first die 254 and plastic deformation starts to occur in the spherical surface portion 206 of the cast shoe member 160. As shown in FIG. 7, in the condition where the parting surfaces 260 and 262 of the first die 254 and the second die 256 is joined to each other, the height of the cast shoe member 160 is reduced, and the diameter of the cast shoe member 160 is increased (enlarged) by an amount equivalent to a surplus material caused as a result of the reduction of the height. The rate of the reduction of the height of the cast shoe member 160 to the height of the formed shoe member 162 is desirably not more than 20% and, in this embodiment, is not more than 8%.

The formed shoe member 162 formed in the abovementioned manner and having the shape of a substantially spherical crown is finished by machining the flat surface portion 272, to have an accurate height, a curved surface having a slightly protruding central portion (for example, a convex spherical surface having a very large radius of curvature), and the tapered surface having a very large taper on periphery of the flat surface portion 272. Further, the whole outer surface of the formed shoe member 162 is subjected to a barrel finishing to improve the surface roughness. This is the surface roughness improvement step.

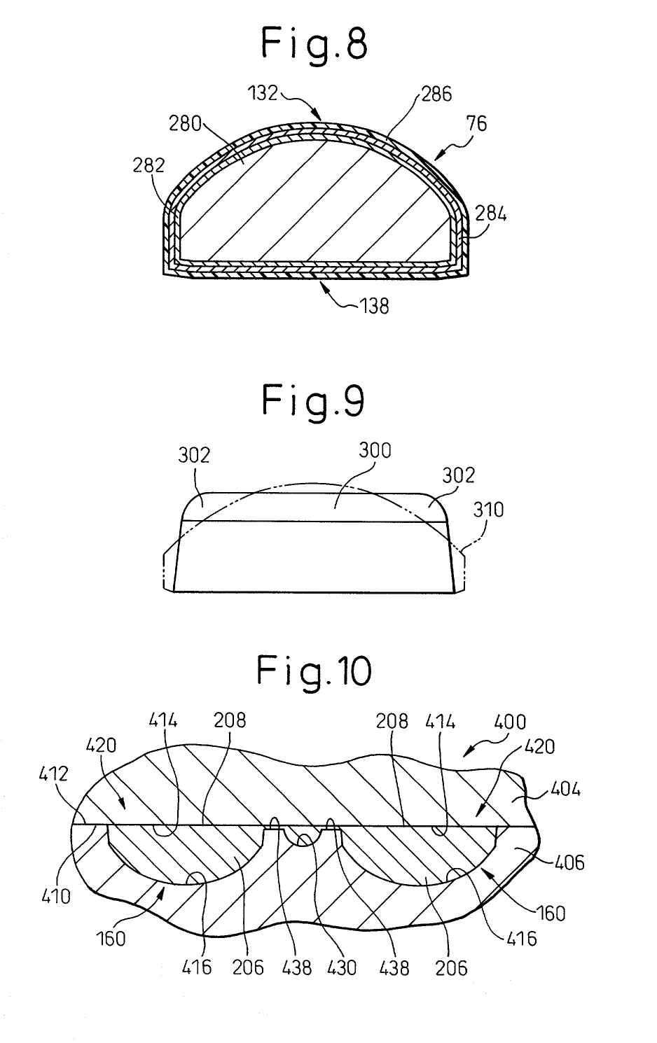

In the subsequent covering step, a coating layer is formed on the outer surface of the formed shoe member 162 (called an intermediate product 280) that has been processed through the machining step and the surface roughness improvement step described above. The coating layer thus formed, as shown in FIG. 8, is desirably composed of a hard plating layer 282 of Ni—P or the like, another hard plating layer 284 of such a material as Ni—B or Ni—P—B—W formed on the hard plating layer 282, and a synthetic resin layer 286 of a material such as polyamide-imide, epoxy resin, polyether ether ketone or phenol resin containing a solid lubricant formed on the hard plating layer 284. For facilitating understanding, FIG. 8 shows the hard plating layers 282 and 284 and the synthetic resin layer 286 exaggerated to a greater thickness. The hard plating layers 282 and 284 are formed by the chemical plating method. The synthetic resin layer 286 is desirably formed by attaching a coating material in liquid form uniformly on the outer surface of the intermediate product 280 by a tumbler process or a spray process. The tumbler process is a method in which a tumbler having a plurality of intermediate products 280 accommodated therein, is rotated while at the same time spraying the coating material from outside the tumbler so as to attach the coating material uniformly. The spray process is a method in which a plurality of intermediate products 280 are arranged and the coating material is uniformly sprayed. If required, before the tumbler process or the spray process, the intermediate products 280 may be subjected to a sandblasting process and/or a chemical process. As other alternatives, only a hard plating layer is formed on the outside of the intermediate products 280, or a hard plating layer containing a solid lubricant is formed on the intermediate products 280 directly or through another hard plating layer, or the coating layer may be formed of any of various other materials. After the tumbler process or the spray process described above, the applied coating material is hardened to form a coating layer, and thus the shoe 76 is completed as a product as shown in FIG. 2.

In this embodiment, the first movable die 184 constitutes a first die and the second movable die 186 constitutes a second die. In this embodiment, the shoe 76 is made of an alsil alloy containing aluminum as a main component and silicon of 10% or more by weight. Thus, the shoe 76 meeting the requirements for both a reduced mass and an increased strength can be obtained. An aluminum alloy having a high silicon content, as in this embodiment, has small ductility and malleability and cracks are liable to occur and the pressing is conventionally difficult if the amount of required plastic deformation is large. In the method of fabricating a spherical crown shoe according to the present invention, however, the required plastic deformation of the cast shoe member 160 is so small that the shoe 76 can be easily fabricated. Also, in view of the fact that the cast shoe member 160 is fabricated by the unidirectional solidification casting method, a shoe 76, which has few defects such as cavity porosity or micro-shrinkage in the material, high quality and high dimensional accuracy, can be fabricated. Further, the waste of the material and the processes can be minimized, thereby leading to a lower fabrication cost. The fabrication cost is further reduced by producing a plurality of shoes 78 at a time.

As a method of fabricating the shoes 76 according to another embodiment, a cast shoe member 300 in the shape shown in FIG. 9 may be cast in the casting step (unidirectional solidification casting step). This cast shoe member 300 has the shape of an equilateral trapezoid having rounded shoulders 302 in longitudinal section, and is lower and thinner than a formed shoe member 410 (indicated by two-dot chain line). The cast shoe member 300 in this shape is formed into the formed shoe member 310 substantially in the shape of a spherical crown by pressing (cold forging) in the folding step using a device similar to the forging die 250 described in the aforementioned embodiment. Specifically, the diameter of the portion of the cast shoe member 300 corresponding to the shoulder portions 302 of the equilateral trapezoid is reduced, and the resultant surplus material flows to the two sides of the shoulder portions 302 (in the vertical direction in FIG. 9), so that the central portion of the cast shoe member 300 is axially expanded, and the portion corresponding to legs of the equilateral trapezoid is expanded toward the outer periphery thereby to form the formed shoe member 310 in the shape of a spherical crown. The height of the cast shoe member 300 is desirably increased to the height of the formed shoe member 310 by not more than 20% or, according to this embodiment, by not more than 8%. The portion corresponding legs of the equilateral trapezoid in the longitudinal section of the cast shoe member can be formed in a slightly curved convex outward, in which case, too, the longitudinal section is still assumed to be a “substantially equilateral trapezoid”.

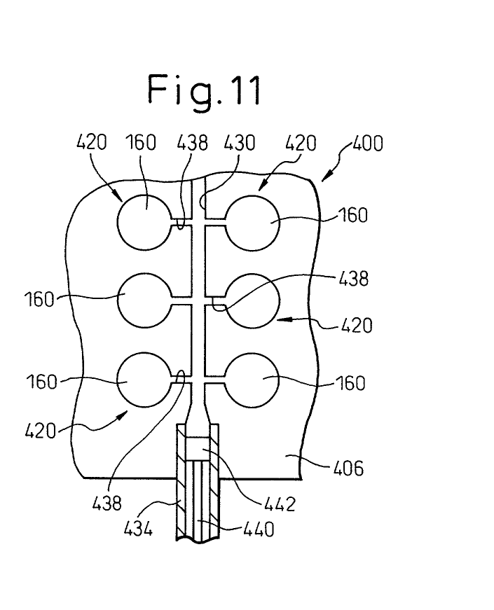

The cast shoe member 160 may alternatively be fabricated by die casting. An embodiment involving such a method will be explained with reference to FIGS. 10 and 11. FIGS. 10 and 11 show a casting die 400 as a major part of the die unit used in the die cast step providing a casting step. The casting die 400, as shown in FIG. 10, includes a first die 404 and a second die 406 movable toward or away from each other to be opened or closed. In this embodiment, one (the second die 406, for example) of the dies is stationary, while the other die (the first die 404, for example) is movable. By driving an elevator device provided with a drive unit (not shown), therefore, the first die 404 can be moved toward or away from the second die 406. In this embodiment, the first die 404 is moved toward or away from the second die 406 in the vertical direction.

The first die 404 and the second die 406 are joined to each other at opposed parting surfaces 410 and 412. Cavity surfaces 414 and 416 are formed in the parting surfaces 410 and 412 at corresponding positions. The cavity surfaces 414 and 416 define cavity 420 in the shape corresponding to the outer shape of the cast shoe member 160. The cavity surface 414 mainly forms the portion of the outer shape of the cast shoe member 160 near the flat surface portion 208, while the cavity surface 416 mainly forms the portion of the outer shape of the cast shoe member 160 near to the spherical surface portion 206. In this embodiment, the cavity surface 414 is located in the same plane as the parting surface 410. A plurality of cavities 420 are arranged, as shown in FIG. 11, in the direction parallel to the parting surfaces 410 and 412 of the first die 404 and the second die 406, so that a plurality of cast shoe members 160 are cast in a single session of injecting the molten metal. The upper end portion (the portion near the first die 404) of each cavity 420 communicates with the internal space of a sleeve 434 having an inlet through a runner 430. The runner 430 includes a single runner which communicates with the internal space of the sleeve 434 and which is branched into a plurality of runners communicating with the upper end portions of respective cavities 420. The parting surface 412 of the second die 406 is formed with a groove having a semicircular cross section. With the parting surfaces 410 and 412 joined with each other, the runner 430 extending in parallel to the parting surfaces 410 and 412 is formed. Each of the end portions of the runner 430 near the cavities 420 is formed with a gate 438 having a cross sectional area smaller than that of the other portions. The sleeve 434 is generally cylindrical in shape and held by the second die 406. A plunger tip 442 arranged at the forward end of the plunger 440 and having a larger diameter than the plunger 440 is slidably fitted in the sleeve 434. The plunger 440 is adapted to move in the sleeve 434 by a plunger drive unit. The plunger drive unit is preferably provided by a hydraulic cylinder which is a kind of fluid pressure cylinder. The sleeve 434, the plunger 440, the plunger tip 442 and the plunger drive unit make up an injection unit for injecting the molten metal (an alsil alloy containing aluminum as a main component and 10% or more by weight of silicon according to this embodiment) from the inlet into the cavities 420.

In the casting step according to this embodiment, with the first and second dies 404 and 406 clamped and the parting surfaces 410 and 412 joined to each other, the molten alsil alloy is injected from the inlet of the sleeve 434. Then, the plunger tip 442 is advanced toward the cavities 420, so that the molten metal is injected into the cavities 420 through the runner 430 and the narrow gates 438. Even after each cavity 420 is filled up with the molten metal, the plunger tip 442 continues to be driven, and therefore the molten metal in the cavity 420 is solidified under sufficient pressure.

After the molten metal is filled up in the cavity 420, the solidification of the material continues for a preset time to cast the cast shoe member 160, and then the first die 404 is separated from the second die 406. Then, after the dies are opened, the cast shoe members 160 are taken out from the die, with the auxiliary portions such as the runner 430 and the biscuit are held by the second die 406 and connected to the cast shoe members 160 providing a product part, and upon activation of an extrusion unit (not shown), they are pushed out from the recesses defined in the cavity surface 416. After that, the individual cast shoe members 160 are separated from each other, and processed in the forming step, the machining step, the surface roughness improvement step and the covering step in the same manner as in the embodiments shown in FIGS. 1 to 8. Therefore, a description will not be given here. Also in this embodiment, each shoe 76 composed of an alsil alloy containing 10% or more by weight of silicon can be readily and accurately fabricated.

The present invention is applicable also to a swash plate compressor of a fixed displacement type such as a swash plate refrigerant compressor comprising two-headed pistons with head portions thereof on the two sides of the engaging portion with the swash plate. The spherical crown shoes of the swash plate compressor of the fixed displacement type are generally greater in height than a hemisphere for such purposes as to prevent the reduction in the area of the sliding surface even in the case where the flat portion of each shoe is worn.

The cast shoe member relating to the present invention can be cast by various casting methods other than the casting methods described above, for example, the vacuum method for sucking off the air in the cavities by an evacuating device, the pore-free diecast method for substituting oxygen for the air in the cavities and thus causing the reaction between the molten metal and oxygen thereby to extinguish the gas in the cavities when the molten metal flows into the cavities, or the diecast method described in Japanese Patent Application No. 11-169564 filed by the present applicant assignee in which the air in the cavities, after being sucked off by a vacuumizing device, is substituted with oxygen.

Several embodiments of the present invention have been described in detail above. However, these embodiments are only illustrative, and various modifications or improvements may be made by those skilled in the art within the spirit and scope of the present invention.

1. A method of fabricating a spherical crown shoe, comprising the steps of:
casting a first shoe member in an aluminum-based alloy, the first shoe member having a shape with a substantially flat surface and a convex curved surface, which is close to a shape of a spherical crown shoe as a product;
forming a second shoe member from the first shoe member by pressing, the second shoe member having a shape of a substantially spherical crown having a substantially flat surface and a substantially convex spherical surface.

2. The method according to claim 1, wherein the casting step comprises a diecasting step.

3. The method according to claim 1, wherein the casting step is carried out using a die unit including a first die having a recess for forming the convex curved surface of the first shoe member and a second die having a surface for forming the flat surface, and wherein the molten metal is injected into the recess from a runner and a gate formed in at least one of parting surfaces of the first die and the second die.

4. The method according to claim 1, wherein the casting step comprises a unidirectional solidification casting step in which solidification of the material advances from the flat surface side to the convex curved surface side of the first shoe member.

5. The method according to claim 4, wherein the unidirectional solidification casting step is carried out using a first die having a recess for forming the convex curved surface of the first shoe member and a gate opening at the deepest portion of the recess, and a second die having cooling means therein and a surface for forming the flat surface of the first shoe member.

6. The method according to claim 1, further comprising the step of removing a useless portion between the casting step and the forming step.

7. The method according to claim 1, wherein the casting step is carried out in such a manner that the convex curved surface is close to a convex spherical surface, and the first shoe member is taller and thinner than the second shoe member.

8. The method according to claim 7, wherein the rate of reduction of the height of the first shoe member to the height of the second shoe member in the forming step is not more than 20%.

9. The method according to claim 1, wherein the casting step is carried out in such a manner that the first shoe member has a longitudinal section substantially in the shape of an equilateral trapezoid with round shoulders, and the first shoe member is lower and thinner than the second shoe member.

10. The method according to claim 9, wherein the rate of increase in the height of the first shoe member to the height of the second shoe member in the forming step is not more than 20%.

11. The method according to claim 1, further comprising the step of improving the surface roughness of the second shoe member.

12. The method according to claim 1, further comprising the step of machining the flat surface portion of the second shoe member.

13. The method according to claim 1, further comprising the step of covering at least a part of the surface of the second shoe member after the forming step.

14. The method according to claim 1, wherein the aluminum-based material comprises an alsil alloy containing silicon of at least 10% by weight.

15. The method according to claim 1, wherein the spherical crown shoe is lower in height than a hemisphere.

16. The method according to claim 1, wherein the spherical crown shoe is taller in height than a hemisphere.
